(19) United States
(12) Patent Application Publication
(10) Pub. No.: US 2024/0039600 A1
(43) Pub. Date: Feb. 1, 2024

(54) SYSTEMS, APPARATUSES, AND METHODS USING CHANNEL STATE INFORMATION (CSI) NORMALIZATION AND QUANTIZATION

(71) Applicant: HUAWEI TECHNOLOGIES CO., LTD., Shenzhen (CN)

(72) Inventors: JUNG HOON SUH, Kanata (CA); Osama ABOUL-MAGD, Kanata (CA); Yan XIN, Kanata (CA); Kwok Shum AU, Ottawa (CA)

(21) Appl. No.: 18/134,743

(22) Filed: Apr. 14, 2023

Related U.S. Application Data
(60) Provisional application No. 63/392,215, filed on Jul. 26, 2022.

(51) Int. Cl. H04B 7/06

(52) U.S. Cl. CPC H04B 7/0626

(57) ABSTRACT

A computerized method performed by a first apparatus. The method has the steps of: normalizing real and imaginary parts of parameters of a channel between the first apparatus and a second apparatus to a first bit-size, and quantizing the normalized real and imaginary parts of the parameters to obtain channel state information (CSI) coefficients of a second bit-size for feeding back to the second apparatus.

### CROSS-REFERENCE TO RELATED APPLICATION

This application claims priority to and the benefit of U.S. Provisional Patent Application Ser. No. 63/392,215, filed Jul. 26, 2022, the content of which is incorporated herein by reference in its entirety.

### FIELD OF THE DISCLOSURE

The present disclosure relates generally to wireless systems, apparatuses, and methods using channel state information (CSI), and in particular to wireless systems, apparatuses, and methods using CSI normalization of quantization.

### BACKGROUND

In wireless communications, channel estimation is usually required for obtaining the channel matrix of a link between two communication devices. For example, an initiator may transmit predefined symbols to a responder. The responder may estimate the channel matrix using the received symbols and feedback the estimated channel matrix to the initiator as coefficients of the channel state information (CSI). The CSI coefficients are quantized.

More specifically, the real and imaginary parts of the elements of the channel matrix are quantized to a predefined target bit-size N_{b} (that is, a target number of bits) using a CSI quantization function and the quantized real and imaginary parts of the elements of the channel matrix are fed back to the initiator as CSI coefficients. As these CSI coefficients are represented as twos-complement integers, a scale factor is required at the initiator to scale them to their original range. The scale factor (which has a predefined scaler bit-size Nₛ) is also fed back to the initiator as a CSI coefficient.

The IEEE Task Group 802.11bf, Sensing (TGbf) has defined that the target bit-size N_{b} is 8 or 10 bits and the scaler bit-size Nₛ is 12 bits. In other words, the CSI coefficients are quantized to 8 or 10 bits per real or imaginary part, per TX-RX link pair and per Ng tone (Ng representing the subcarrier group size), and the scale factors are quantized to 12 bits per TX-RX link pair.

However, the IEEE TGbf does not define the implementation detail of CSI coefficients, and different WI-FI® device manufacturers or vendors may have different implementations of CSI coefficients (WI-FI is a registered trademark of Wi-Fi Alliance, Austin, TX, USA). Consequently, the bit size of the real and imaginary parts of the elements of the channel matrix may be vendor-dependent and thus may be different from vendor to vendor.

For example, each of the real and imaginary parts of the elements of the channel matrix is Nₚ bits, which may be implemented by some vendors as integers of a bit-size greater than the scaler bit-size Nₛ (for example, more than 12 bits). Consequently, the value of CSI coefficients after the normalization by the scale factor can be larger than one (1), which may be difficult to be controlled under the requirement of N_{b} bits (for example, 8 or 10 bits) per real or imaginary part, per TX-RX link pair and per Ng tone with the simple fixed-point conversion equation.

### SUMMARY

According to one aspect of this disclosure, there is provided a computerized method comprising: normalizing real and imaginary parts of estimated parameters of a channel to a first bit-size; and quantizing the real and imaginary parts of the normalized parameters to obtain channel state information (CSI) coefficients of a second bit-size for feeding back to a device.

In some embodiments, the device is a WI-FI® device.

In some embodiments, the channel comprises one or more transmitter-receiver (TX-RX) links, and the estimated parameters of the channel comprise the estimated parameters of the one or more TX-RX links; the method further comprises: obtaining a real-part maximum an imaginary-part maximum of real and imaginary parts of the estimated parameters or the normalized parameters of each TX-RX link, respectively, and obtaining a real-part scale factor and an imaginary-part scale factor for each TX-RX link by respectively scaling and rounding the real-part and imaginary-part maximums of the TX-RX link to the first bit-size; and said quantizing the real and imaginary parts of the normalized parameters of the channel comprises: scaling the real and imaginary parts of the normalized parameters of each TX-RX link using the corresponding real-part and imaginary-part scale factors, and quantizing the scaled real and imaginary parts of the normalized parameters of each TX-RX link to the first bit-size to obtain the CSI coefficients of the TX-RX link.

In some embodiments, said scaling the real and imaginary parts of the normalized parameters of each TX-RX link comprises: dividing the real and imaginary parts of the normalized parameters of each TX-RX link by the corresponding real-part and imaginary-part scale factors.

In some embodiments, the first bit-size is 12 bits.

In some embodiments, the second bit-size is 8 or 10 bits.

In some embodiments, the method further comprises: obtaining the estimated parameters of the channel before said normalizing the real and imaginary parts of the normalized parameters of the channel; and sending the CSI coefficients to the device.

According to one aspect of this disclosure, there is provided a module comprising: one or more one or more circuits for performing above-described method.

According to one aspect of this disclosure, there is provided one or more non-transitory, computer-readable storage media comprising computer-executable instructions, wherein the instructions, when executed, cause at least one processing unit to perform above-described method.

By using the above-described, the obtained CSI coefficients and scale factors are properly quantized as needed and/or in accordance with the requirements of relevant standards, thereby hiding different channel estimation implementations of different vendors and ensuring inter-operability between initiators and responders of different vendors without the burden of revising their channel estimation implementations.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station of the communication system shown in FIG. 1;

FIG. 4 is a simplified schematic diagram showing a conventional process for channel estimation; and

FIG. 5 is a simplified schematic diagram showing a process for channel estimation with normalization and quantization of channel parameters, according to some embodiments of this disclosure.

### DETAILED DESCRIPTION

Embodiments disclosed herein relate to wireless systems, apparatuses, and methods using channel state information (CSI) normalization and quantization. The wireless systems, apparatuses, and methods disclosed herein may be any suitable systems, apparatuses, and methods for transmitting wireless signals. One example of such systems may be WIFI® systems (WI-FI is a registered trademark of Wi-Fi Alliance, Austin, TX, USA). Other examples of such systems may be 5G, 6G, or other applicable future wireless mobile communication systems, and the like.

### A. System Structure

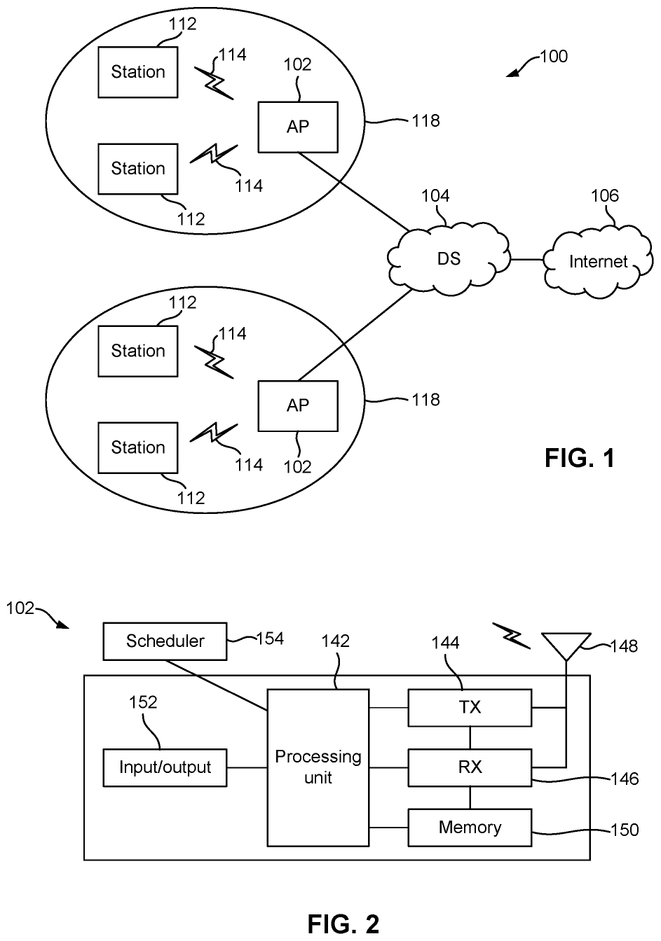

Turning now to FIG. 1, a communication system according to some embodiments of this disclosure is shown and is generally identified using reference numeral 100. As an example, the communication system 100 in these embodiments may be a WIFI® system built under relevant standards such as IEEE 802. 11 standards. As shown, the communication system 100 comprises one or more interconnected networking devices 102 such as one or more interconnected access points (APs; also called “base stations”) forming a distribution system (DS) 104. The DS 104 is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations (STAs) 112 through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142, at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102.

The processing unit 142 is a circuit for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118 using, for example, multiple-input multiple-output (MIMO) technology. Moreover, orthogonal frequency-division multiplexing (OFDM) may be used wherein the channel 114 is partitioned into a plurality orthogonal subchannels for communication between the AP 102 and the STA 112.

Each memory 150 may comprise one or more non-transitory, computer-readable, volatile and/or non-volatile storage media such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

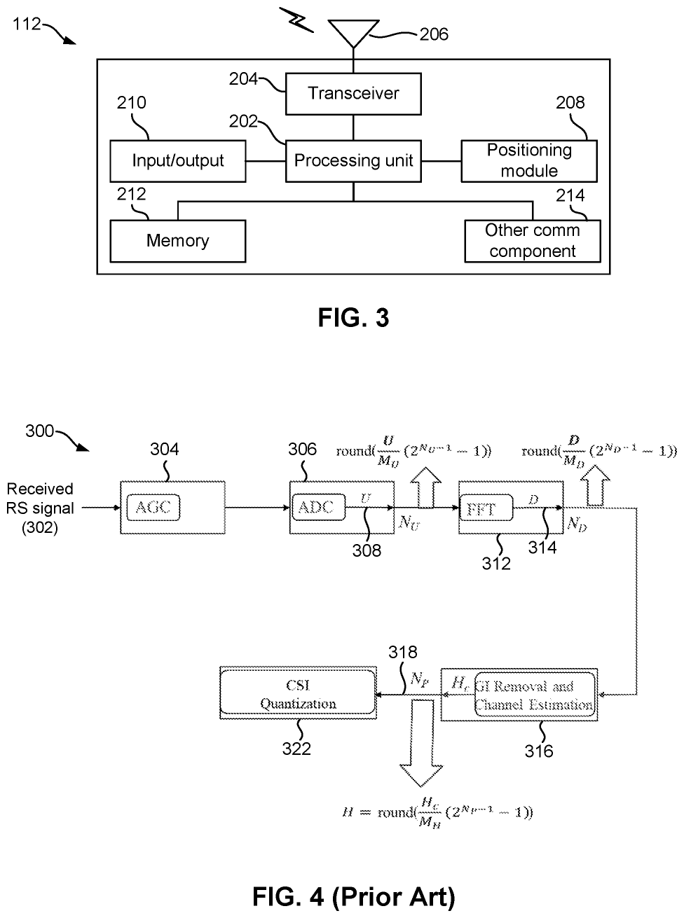

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214.

The processing unit 202 is a circuit for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise one or more non-transitory, computer-readable, volatile and/or non-volatile storage media and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102 using, for example, MIMO technology. A STA 112 may also use OFDM for communication with the AP 102.

In the following, the APs 102 and STAs 112 are generally classified as transmitters and receivers, wherein an AP 102 may be a transmitter when it is transmitting a wireless signal or a receiver when it is receiving a wireless signal. Similarly, a STA 112 may be a transmitter when it is transmitting a wireless signal or a receiver when it is receiving a wireless signal.

### B. Channel State Information

As those skilled in the art understand, the channel 114 between an AP 102 and a STA 112 generally comprises one or more TX-RX links (also called “TX-RX link pairs”) each corresponding to a pair of TX and RX. Depending on the communication direction, the TX and RX may be respectively on the AP and STA sides or may be respectively on the STA and AP sides.

The channel 114 may be estimated by sending a set of predefined symbols (as the Reference Signal (RS)) from an initiator (which may be the AP 102 or the STA 112) to a responder (which may accordingly be the STA 112 or the AP 102). The responder uses the received symbols and the predefined symbols to estimate the parameters of the channel 114 and feedback the estimated channel parameters to the initiator as the channel station information (CSI). FIG. 4 shows a conventional process 300 for estimating the parameters of the channel 114 performed by, for example, a digital signal processor (DSP) of the responder.

As shown, the responder receives the RS signal 302 (which is a time-domain analog signal) from the initiator and passes it through an auto-gain control (AGC) unit 304 for automatically adjusting the gain of the received RS signal 302, which is then converted to a time-domain digital signal 308 of an amplitude U by an analog-to-digital (ADC) unit 306. Herein, the time-domain digital signal 308 and other digital signals generated at the subsequent steps are represented in the DSP as fixed-point numbers such as twos-complement numbers. Then, the amplitude U of the time-domain digital signal 308 is represented as:

$$round ( \frac{U}{{M}_{U}} ( {2}^{{N}_{U} - 1} - 1 ) ) .$$

where M_{U} is the maximum amplitude of the time-domain digital signal 308, N_{U} is the number of bits of the time-domain digital signal 308, and round(x) is the round function that rounds x to its nearest integer.

In this example, the first and second parties use OFDM for communication therebetween. Thus, the responder converts the time-domain digital signal 308 into a frequency-domain digital signal 314 using the digital Fourier transform such as the fast Fourier transform (FFT) 312. As those skilled in the art understand, each sample of the frequency-domain digital signal 314 is a complex number, and each of the real and imaginary parts thereof may be separately represented as a fixed-point number. For example, the real part of the frequency-domain digital signal 314 having an amplitude D may be represented as:

$$round ( \frac{D}{{M}_{D}} ( {2}^{{N}_{D} - 1} - 1 ) ) .$$

where M_{D} is the maximum amplitude of the real part of the frequency-domain digital signal 314, and N_{D} is the number of bits of the real part of the frequency-domain digital signal 314. The imaginary part of the frequency-domain digital signal 314 may be represented in a similar manner.

Then, a channel estimation function 316 is used to remove the guard interval (also called the “cyclic prefix”) of the frequency-domain digital signal 314 and estimate the channel parameters 318 (also denoted “channel frequency response” or “channel matrix” for MIMO systems) which are also complex numbers. The channel parameters 318 may be conveniently organized as a channel matrix, wherein the parameters of each link may be organized in the channel matrix as a row or a column (depending on the presentation of the channel matrix), and each channel parameter may be denoted an element of the channel matrix.

As shown in FIG. 4, the real part of each element of the channel matrix 318 having an amplitude H_{C} may be represented as:

$$round ( \frac{{H}_{C}}{{M}_{H}} ( {2}^{{N}_{P} - 1} - 1 ) ) .$$

Where M_{H} is the maximum amplitude of the real parts of the elements of the channel matrix 318, and N_{P} is the number of bits of the real part of each element of the channel matrix 318. The imaginary part of each element of the channel matrix 318 may be represented in a similar manner.

The real and imaginary parts of the elements of the channel matrix 318 are then quantized to a predefined target bit-size N_{b} (that is, a target number of bits) using a CSI quantization function 322 and the quantized real and imaginary parts of the elements of the channel matrix 318 are fed back to the initiator as CSI coefficients. As these CSI coefficients are represented as twos-complement integers, a scale factor is required at the initiator to scale them to their original range. The scale factor (which has a predefined scaler bit-size Nₛ) is also fed back to the initiator as a CSI coefficient.

The IEEE Task Group 802.11bf, Sensing (TGbf) has defined that the target bit-size N_{b} is 8 or 10 bits and the scaler bit-size Nₛ is 12 bits. In other words, the CSI coefficients are quantized to 8 or 10 bits per real or imaginary part, per TX-RX link pair and per Ng tone (Ng representing the subcarrier group size), and the scale factors are quantized to 12 bits per TX-RX link pair.

As the IEEE TGbf does not define the implementation detail of CSI coefficients which are passed from the channel estimation function block 316, different WIFI® device manufacturers or vendors may have different implementations of CSI coefficients. Consequently, the bit size of the real and imaginary parts of the elements of the channel matrix 318 may be vendor-dependent and thus may be different from vendor to vendor.

For example, each of the real and imaginary parts of the elements of the channel matrix 318 is Nₚ bits, which may be implemented by some vendors as integers of a bit-size greater than the scaler bit-size Nₛ (for example, more than 12 bits). Consequently, the value of CSI coefficients after the normalization by the scale factor can be larger than one (1), which may be difficult to be controlled under the requirement of N_{b} bits (for example, 8 or 10 bits) per real or imaginary part, per TX-RX link pair and per Ng tone with the simple fixed-point conversion equation.

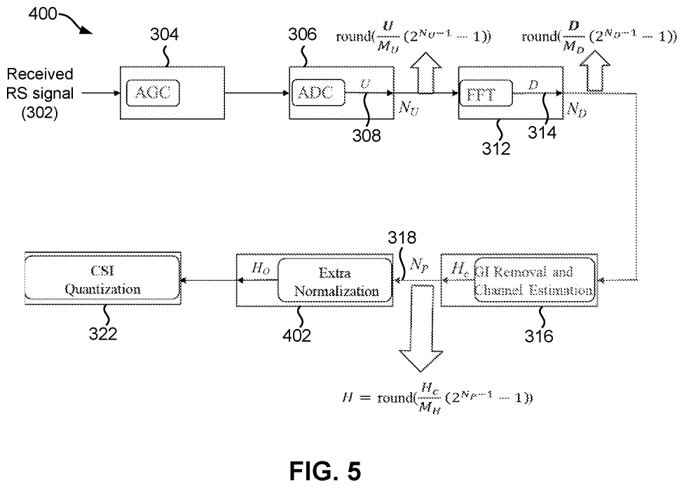

FIG. 5 shows a computerized process 400 for channel estimation performed by, for example, a DSP of the responder, according to some embodiments of this disclosure. The process 400 is similar to the prior-art process 300 shown in FIG. 4 except that the process 400 comprises a normalization step 402 between the channel estimation function 316 and the CSI quantization function 322 to normalize the channel parameters such that the CSI coefficients (that is, the quantized channel parameters, that is, the channel parameters 318 divided by the scale factor and then rounded to a predefined precision) to be smaller than one (1) to control the output bit size of the CSI quantization function 322 under N_{b} bits (for example, 8 or 10 bits) for feeding back to the initiator.

The detail of the normalization step 402 is as follows:
1. obtaining the maximums m_{H}ⁱ(n,l) and m_{H}^{q}(n,l), where n and l represent the TX and RX indices, respectively, of the real and imaginary parts, respectively, of the elements of the channel matrix 318 corresponding to the link pair of the n-th TX and the l-th RX; note that m_{H}ⁱ(n,l) and m_{H}^{q}(n,l) are vendor-dependent and may be more than Nₛ bits (for example, 12 bits); here, “i” refers to “in-phase” and “q” refers to “quadrature-phase”; for ease of description, m_{H}ⁱ(n,l) and m_{H}^{q}(n,l) are denoted the “real-part maximum” and the “imaginary-part maximum”, respectively.
2. obtaining a Nₛ-bit real-part scale factor iM_{H}(n,l) and a Nₛ-bit imaginary-part scale factor qM_{H}(n,l) for each TX-RX link pair from the corresponding real-part and imaginary-part maximums, respectively, as follows:

iM_{H}(n,l)=round(m_{H}ⁱ(n,l)*2^{K})

qM_{H}(n,l)=round (m_{H}^{q}(n,l)*2^{K})

where the parameter K is selected (for example, by the vendor) to make iM_{H}(n,l) and qM_{H}(n,l) within the scaler bit-size Nₛ (for example, the 12-bit range);
3. obtaining the normalized channel parameters by normalizing the real parts iH(n,l,k) and the imaginary parts qH(n,l,k) of the channel parameters 318, where k represents the subcarrier index, output from the channel estimation function 316 (shown as Hc in FIG. 5 for simplicity) as:

iHₒ(n,l,k)=round (iH(n,l,k)*(2^{α}−1))

qHₒ(n,l,k)=round (aH(n,l,k)*(2^{α}−1))

where iHₒ(n,l,k) and qHₒ(n,l,k) are the real and imaginary parts, respectively, of normalized channel parameters, and the parameter a is selected to make each of iHₒ(n,l,k) and qHₒ(n,l,k) to have a bit-size Nₛ (that is, within the range of [−(2^{N}^{ₛ}−1), (2^{N}^{ₛ}−1) ]), such that the outputs iHₑ(n,l,k) and qHₑ(n,l,k) of the CSI quantization function 322 (that is, the CSI coefficients; see below) within the range of [−(2^{(N}^{_{b}}⁻¹⁾−1), (2^{(N}^{_{b}}⁻¹⁾−1)].
4. obtaining the N_{b}-bit CSI coefficients iHₑ(n,l,k) and qHₑ(n,l,k) using the normalized channel parameters obtained at step 4 and the corresponding scale factors obtained at step 3 as:

$${iH}_{e} ( n , l , k ) = round ( \frac{{iH}_{o} ( n , l , k )}{{iM}_{H} ( n , l )} ( {2}^{( {N}_{b} - 1 )} - 1 ) ) \\ {qH}_{e} ( n , l , k ) = round ( \frac{{qH}_{o} ( n , l , k )}{{qM}_{H} ( n , l )} ( {2}^{( {N}_{b} - 1 )} - 1 ) )$$

Then, the CSI coefficients are fed back to the initiator.

After receiving the CSI coefficients, the initiator recovers the channel matrix as:

$${iH}_{d} ( n , l , k ) = round ( \frac{i {\tilde{H}}_{e} ( m , l , k ) * i {\tilde{M}}_{H} ( n , l )}{( {2}^{( {N}_{b} - 1 )} - 1 )} ) \\ {qH}_{d} ( n , l , k ) = round ( \frac{q {\tilde{H}}_{e} ( m , l , k ) * q {\tilde{M}}_{H} ( n , l )}{( {2}^{( {N}_{b} - 1 )} - 1 )} )$$

where iH_{d}(n,l,k) and qH_{d}(n,l,k) are the recovered CSI coefficients, d\tilde{H}ₑ(n,l,k) and q\tilde{H}ₑ(n,l,k) are received CSI coefficients, and i\tilde{M}_{H}(n,l) and q\tilde{M}_{H}(n,l) are the received scale factors at the initiator. The recovered CSI coefficients iH_{d}(n,l,k) and qH_{d}(n,l,k) correspond to iHₒ(n,l,k) and qHₒ(n,l,k) in the responder (see FIG. 5).

By using the normalization step 402, the final CSI coefficients and the scale factors are properly quantized in accordance with the requirements of relevant standards, thereby hiding different channel estimation implementations of different vendors and ensuring inter-operability between initiators and responders of different vendors without the burden of revising their channel estimation implementations.

For example, with the normalization step 402, the values of the scale factors are quantized to the scaler bit-size Nₛ (for example, 12 bits) per TX-RX Link pair (that is, ranged within the range of [1, (2 ^{N}^{ₛ}−1)]. The scale factors are used to normalize the channel parameters to make the CSI coefficients within the range of [−(2^{(N}^{_{b}}⁻¹⁾−1), (2^{(N}^{_{b}}⁻¹⁾−1)].

Those skilled in the art will appreciate that other embodiments are readily available. For example, depending on implementation and/or the requirements of relevant standards, the above-described bit-sizes may vary.

In some embodiments, the detail of the normalization step 402 is as follows:
1. obtaining the normalized channel parameters by normalizing the real parts iH(n,l,k) and the imaginary parts qH(n,l,k) of the channel parameters 318, where k represents the subcarrier index, output from the channel estimation function 316 as:

iHₙ(n,l,k)=round(iH(n,l,k)*(2^{α}−1)

qHₙ(n,l,k)=round (qH(n,l,k)*(2^{α}−1)

where iHₙ(n,l,k) and qHₙ(n,l,k) are the real and imaginary parts, respectively, of normalized channel parameters, and the parameter a is selected to make each of iHₙ(n,l,k) and qHₙ(n,l,k) to have a bit-size Nₛ (that is, within the range of [−(2^{N}^{ₛ}−1), (2^{N}^{ₛ}−1)]);
2. obtaining the real-part and imaginary-part maximums m_{H}ⁱ(n,l) and m_{H}^{q}(n,l) of the real and imaginary parts, respectively, of the elements of the normalized channel parameters (or the normalized channel matrix obtained at step 1) corresponding to the link pair of the n-th TX and the l-th RX; note that m_{H}ⁱ(n,l) and m_{H}^{q}(n,l) are vendor-dependent and may be more than Nₛ bits (for example, 12 bits);
3. obtaining a Nₛ-bit real-part scale factor iM_{H}(n,l) and a Nₛ-bit imaginary-part scale factor qM_{H}(n,l) for each TX-RX link pair from the corresponding real-part and imaginary-part maximums, respectively, as follows:

iM_{H}(n,l)=m_{H}ⁱ(n,l)

qM_{H}(n,l)=m_{H}^{q}(n,l)
4. obtaining the N_{b}-bit CSI coefficients iHₑ(n,l,k) and qHₑ(n,l,k) using the normalized channel parameters obtained at step 4 and the corresponding scale factors obtained at step 3 as:

$${iH}_{e} ( n , l , k ) = round ( \frac{{iH}_{o} ( n , l , k )}{{iM}_{H} ( n , l )} ( {2}^{( {N}_{b} - 1 )} - 1 ) ) \\ {qH}_{e} ( n , l , k ) = round ( \frac{{qH}_{o} ( n , l , k )}{{qM}_{H} ( n , l )} ( {2}^{( {N}_{b} - 1 )} - 1 ) )$$

Then, the CSI coefficients are fed back to the initiator.

Those skilled in the art will appreciate that the above-described method may be implemented in any suitable manner, for example, as computer-executable instructions stored in one or more non-transitory computer-readable storage media, as one or more modules having one or more circuits for performing the above-described method, in one or more chipsets having one or more circuits for performing the above-described method, in one or more devices or apparatuses having one or more circuits for performing the above-described method, and/or the like.

### C. Acronym Key

CSI: Channel State Information
DSP: Digital Signal Processor
Ng: Number of Subcarrier Group
RX: Receiver
TGbf: IEEE Task Group 802.11bf, Sensing
TX: Transmitter

Although embodiments have been described above with reference to the accompanying drawings, those of skill in the art will appreciate that variations and modifications may be made without departing from the scope thereof as defined by the appended claims.

What is claimed is:

1. A computerized method comprising:
normalizing real and imaginary parts of estimated parameters of a channel to a first bit-size; and
quantizing the real and imaginary parts of the normalized parameters to obtain channel state information (CSI) coefficients of a second bit-size for feeding back to a device.

2. The method of claim 1, wherein the device is a WI-FI® device.

3. The method of claim 1, wherein the channel comprises one or more transmitter-receiver (TX-RX) links, and the estimated parameters of the channel comprise the estimated parameters of the one or more TX-RX links;
wherein the method further comprises:
obtaining a real-part maximum and an imaginary-part maximum of real and imaginary parts of the estimated parameters or the normalized parameters of each TX-RX link, respectively, and
obtaining a real-part scale factor and an imaginary-part scale factor for each TX-RX link by respectively scaling and rounding the real-part and imaginary-part maximums of the TX-RX link to the first bit-size; and
wherein said quantizing the real and imaginary parts of the normalized parameters of the channel comprises:
scaling the real and imaginary parts of the normalized parameters of each TX-RX link using the corresponding real-part and imaginary-part scale factors, and
quantizing the scaled real and imaginary parts of the normalized parameters of each TX-RX link to the first bit-size to obtain the CSI coefficients of the TX-RX link.

4. The method of claim 3, wherein said scaling the real and imaginary parts of the normalized parameters of each TX-RX link comprises:
dividing the real and imaginary parts of the normalized parameters of each TX-RX link by the corresponding real-part and imaginary-part scale factors.

5. The method of claim 1, wherein the first bit-size is 12 bits.

6. The method of claim 1, wherein the second bit-size is 8 or 10 bits.

7. The method of claim 1 further comprising:
obtaining the estimated parameters of the channel before said normalizing the real and imaginary parts of the normalized parameters of the channel; and
sending the CSI coefficients to the device.

8. A module comprising:
one or more one or more circuits for;
normalizing real and imaginary parts of estimated parameters of a channel to a first bit-size; and
quantizing the real and imaginary parts of the normalized parameters to obtain channel state information (CSI) coefficients of a second bit-size for feeding back to a device.

9. The module of claim 8, wherein the module is or is a part of a WI-FI® apparatus; and wherein the device is another WI-FI® apparatus.

10. The module of claim 8, wherein the channel comprises one or more transmitter-receiver (TX-RX) links, and the estimated parameters of the channel comprise the estimated parameters of the one or more TX-RX links;
wherein the module is further configured for:
obtaining a real-part maximum an imaginary-part maximum of real and imaginary parts of the estimated parameters or the normalized parameters of each TX-RX link, respectively, and
obtaining a real-part scale factor and an imaginary-part scale factor for each TX-RX link by respectively scaling and rounding the real-part and imaginary-part maximums of the TX-RX link to the first bit-size; and
wherein said quantizing the real and imaginary parts of the normalized parameters of the channel comprises:
scaling the real and imaginary parts of the normalized parameters of each TX-RX link using the corresponding real-part and imaginary-part scale factors, and
quantizing the scaled real and imaginary parts of the normalized parameters of each TX-RX link to the first bit-size to obtain the CSI coefficients of the TX-RX link.

11. The module of claim 10, wherein said scaling the real and imaginary parts of the normalized parameters of each TX-RX link comprises:
dividing the real and imaginary parts of the normalized parameters of each TX-RX link by the corresponding real-part and imaginary-part scale factors.

12. The module of claim 8, wherein the first bit-size is 12 bits.

13. The module of claim 8, wherein the second bit-size is 8 or 10 bits.

14. The module of claim 8, wherein the at least one processing unit is further configured for:
obtaining the estimated parameters of the channel before said normalizing the real and imaginary parts of the normalized parameters of the channel; and
sending the CSI coefficients to the device.

15. One or more non-transitory, computer-readable storage media comprising computer-executable instructions, wherein the instructions, when executed, cause at least one processing unit to perform actions comprising:
normalizing real and imaginary parts of estimated parameters of a channel to a first bit-size; and
quantizing the real and imaginary parts of the normalized parameters to obtain channel state information (CSI) coefficients of a second bit-size for feeding back to a device.

16. The one or more non-transitory, computer-readable storage media of claim 15, wherein the channel comprises one or more transmitter-receiver (TX-RX) links, and the estimated parameters of the channel comprise the estimated parameters of the one or more TX-RX links;
wherein the instructions, when executed, cause the at least one processing unit to perform further actions comprising:
obtaining a real-part maximum an imaginary-part maximum of real and imaginary parts of the estimated parameters or the normalized parameters of each TX-RX link, respectively, and
obtaining a real-part scale factor and an imaginary-part scale factor for each TX-RX link by respectively scaling and rounding the real-part and imaginary-part maximums of the TX-RX link to the first bit-size; and
wherein said quantizing the real and imaginary parts of the normalized parameters of the channel comprises:
scaling the real and imaginary parts of the normalized parameters of each TX-RX link using the corresponding real-part and imaginary-part scale factors, and
quantizing the scaled real and imaginary parts of the normalized parameters of each TX-RX link to the first bit-size to obtain the CSI coefficients of the TX-RX link.

17. The one or more non-transitory, computer-readable storage media of claim 16, wherein said scaling the real and imaginary parts of the normalized parameters of each TX-RX link comprises:
dividing the real and imaginary parts of the normalized parameters of each TX-RX link by the corresponding real-part and imaginary-part scale factors.

18. The one or more non-transitory, computer-readable storage media of claim 15, wherein the first bit-size is 12 bits.

19. The one or more non-transitory, computer-readable storage media of claim 15, wherein the second bit-size is 8 or 10 bits.

20. The one or more non-transitory, computer-readable storage media of claim 15, wherein the instructions, when executed, cause the at least one processing unit to perform further actions comprising:
obtaining the estimated parameters of the channel before said normalizing the real and imaginary parts of the normalized parameters of the channel; and
sending the CSI coefficients to the device.
